(19) United States
(12) Patent Application Publication
(10) Pub. No.: US 2024/0296069 A1
(43) Pub. Date: Sep. 5, 2024

(54) PROACTIVE THERMAL MANAGEMENT OF A DETERMINISTIC PROCESSOR TO IMPROVE LATENCY, THROUGHPUT, AND RELIABILITY

(71) Applicant: Groq, Inc., Mountain View, CA (US)

(72) Inventors: Santosh Raghavan, San Jose, CA (US); Zhi Yang, Syosset, NY (US); Igor Arsovski, Williston, VT (US)

(21) Appl. No.: 18/593,543

(22) Filed: Mar. 1, 2024

Related U.S. Application Data
(60) Provisional application No. 63/488,052, filed on Mar. 2, 2023.

(51) Int. Cl. G06F 9/48

(52) U.S. Cl. CPC G06F 9/4893

(57) ABSTRACT

Proactive thermal management of a deterministic processor to improve latency, throughput, and reliability is provided herein. Embodiments improve the compiler of a deterministic processor to calculate the estimated power and temperature profile of a program and/or workload over time, to then proactively schedule necessary and adequate cooling resources, and/or add dead compute cycles and other power reduction methods, to maintain the processor temperature within a specific “safe” range of operation while maximizing performance, efficiency and/or other figures of merit. Proactive thermal management by the compiler will increase processor throughput, and avoid unsafe temperature excursions, to improve the reliability and extend the lifetime of the processor. This Abstract and the independent Claims are concise signifiers of embodiments of the claimed inventions. The Abstract does not limit the scope of the claimed inventions.

### CROSS-REFERENCE TO RELATED APPLICATIONS

This application claims the benefit of priority to U.S. Provisional Application No. 63/488,052, filed Mar. 2, 2023, and entitled “PROACTIVE THERMAL MANAGEMENT OF A DETERMINISTIC PROCESSOR TO IMPROVE LATENCY, THROUGHPUT, AND RELIABILITY” the entirety of which is expressly incorporated herein by reference.

### COPYRIGHT NOTICE

This patent document can be exactly reproduced as it appears in the files of the United States Patent and Trademark Office, but the assignee(s) otherwise reserves all rights in any subsets of included original works of authorship in this document protected by 17 USC 102 (a) of the U.S. copyright law.

### SPECIFICATION—DISCLAIMERS

In the following Background, Summary, and Detailed Description, paragraph headings are signifiers that do not limit the scope of an embodiment of a claimed invention (ECIN). The citation or identification of any publication signifies neither relevance nor use as prior art. A paragraph for which the font is all italicized signifies text that exists in one or more patent specifications filed by the assignee(s).

A writing enclosed in double quotes (“ ”) signifies an exact copy of a writing that has been expressed as a work of authorship. Signifiers, such as a word or a phrase enclosed in single quotes (‘ ’), signify a term that as of yet has not been defined and that has no meaning to be evaluated for, or has no meaning in that specific use (for example, when the quoted term ‘module’ is first used) until defined.

### FIELD(S) OF TECHNOLOGY

This disclosure has general significance in the field of power management in processors, in particular, significance for the following topics: synthesizing clock waveforms for more efficient power management in high-speed processors. This information is limited to use in the searching of the prior art.

### BACKGROUND

Increasing demand for high performance computing and artificial intelligence workloads is increasing the power envelopes of processors to unprecedented levels. Simultaneously, improvements in silicon technology have resulted in increased power density of functional blocks in ever smaller physical layouts for processors. As a result, both local and global power density poses great challenges for thermal management design and optimization. Failure to maintain a safe operating silicon temperature will lead to performance degradation and/or physical hardware damage of the processor. Current reactive thermal management methods use sensors on the processor to detect temperature excursions. If the processor temperature exceeds a certain threshold, the operating frequency will either be modulated to a lower value to reduce power consumption, or the workload execution is stalled until the temperature reaches a safe range before resumption. Such a reactive approach introduces significant uncertainty in processor performance in terms of latency, throughput and reliability. The inherent non-deterministic nature of traditional processors leads to unpredictable power consumption at any given time (clock cycle), which in turn further complicates the thermal management design.

The uncertainty of power consumption profiles in non-deterministic processors is usually compensated by over-designed thermal solutions that provide unnecessarily high cooling rates at all times in order to ensure processor performance and reliability. Such over-designed solutions result in large amounts of cooling power being wasted and increase the overall cost of the cooling system.

### SUMMARY

This Summary, together with any Claims, is a brief set of signifiers for at least one ECIN (which can be a discovery, see 35 USC 100 (a); and see 35 USC 100 (j)), for use in commerce for which the Specification and Drawings satisfy 35 USC 112.

Methods are disclosed herein to improve the compiler of a deterministic processor to calculate the estimated power consumption and the resulting temperature profile of a program and/or workload (e.g., a scheduled program and/or a scheduled workload) over time, which is calculated before the execution of the program on the deterministic processor. This information is used to proactively manage the system temperature, before the program has begun execution, to minimize or mitigate temperature excursions outside a specific safe range.

In one ECIN, during the compilation of a program, the stages of power consumption and temperature excursions of a workload are identified, and information is shared with cooling controllers off of the processor to proactively schedule and apply the necessary and adequate cooling resources, prior to the thermal events, maximizing performance while avoiding unsafe temperatures and thermal runaway events. Cooling resources are defined as, but not limited to, air cooling, direct liquid cooling, cold plate cooling, vapor chamber, 2-phase cooling, thermoelectric cooling, immersion cooling etc.

In another ECIN, during the compilation, information on the predicted power and temperature profile of the workload is combined with information on maximum available cooling resources, to determine techniques for workload derates. The workload derate techniques include, for example, but are not limited to, lower on-chip resource utilization, lowering the frequency of processor using dynamic voltage frequency scaling (DVFS), inserting dead cycles in the middle of the scheduled workload, and/or other methods that the compiler can control to reduce power. This allows the processor to achieve the maximum performance while maintaining temperature in the safe operation range.

In another ECIN, during the compilation, the stages of power and temperature profile of the workload are combined with maximum available cooling resources to increase on-chip resource utilization and/or increasing the frequency of processor using dynamic voltage frequency scaling (DVFS), and/or other methods that the compiler can generate instructions to increase power and reduce the latency of workload execution, while maximizing performance and maintaining the processor temperature within the safe operation range.

In ECIN, the compiler is provided with data for the spatial distribution of the ambient temperature across different processors within a system (for example, a single rack consisting of multiple processors) that share the same cooling resources. During the compilation, the ambient temperature information around each processor is combined with stages of power and temperature profile of the workload, to adjust the resource utilization, processor frequency, etc. to maximize performance while minimizing cooling resource related costs.

This Summary does not completely signify any ECIN. While this Summary can signify at least one essential element of an ECIN enabled by the Specification and Figures, the Summary does not signify any limitation in the scope of any ECIN.

### BRIEF DESCRIPTION OF THE DRAWINGS

The following Detailed Description, Figures, and Claims signify the uses of and progress enabled by one or more ECINs. All of the Figures are used only to provide knowledge and understanding and do not limit the scope of any ECIN. Such Figures are not necessarily drawn to scale.

FIG. 1 illustrates a system for compiling a program to be executed on a specialized processor, in accordance with some embodiments.

FIGS. 2A and 2B illustrate instruction and data flow in a processor having a functional slice architecture, in accordance with some embodiments.

FIGS. 3A and 3B illustrates the difference between the traditional reactive thermal management procedure vis-a-vis the proactive approach proposed herein.

FIGS. 4A and 4B illustrate the difference in the processor power consumption, cooling rate, and operation temperature profiles between the reactive and proactive thermal management approaches, for a nominal workload.

FIG. 5 illustrates the processor power consumption, cooling rate, and operation temperature profiles of a high power intensity workload utilizing the proactive thermal management approach.

FIGS. 6A and 6B illustrates the difference in the processor power consumption, cooling rate, and operation temperature profiles of a low power intensity workload between the reactive and proactive thermal management approaches.

FIGS. 7A and 7B illustrate the difference in ambient temperature of the cooling solution based on the direction of cooling flow and increasing ambient temperature within a system comprising multiple processors. In the proactive thermal management approach, the difference in processor power consumption, cooling rate and operation temperature profiles, are shown for different ambient temperatures.

FIG. 8 illustrates the difference in ambient temperature of the cooling solution within a system comprising multiple processors. In the proactive thermal management approach, the difference in processor power consumption, cooling rate and operation temperature profiles, are shown for different ambient temperatures.

FIGS. 9A and 9B illustrate the difference in the reliability and lifetime management procedure of current reactive approach vis-a-vis the proactive approach proposed herein.

FIGS. 10 and 11 illustrate various computer systems in which the disclosed embodiment can be utilized.

The Figures can have the same, or similar, reference signifiers in the form of labels (such as alphanumeric symbols, e.g., reference numerals), and can signify a similar or equivalent function or use. Further, reference signifiers of the same type can be distinguished by appending to the reference label a dash and a second label that distinguishes among the similar signifiers. If only the first label is used in the Specification, its use applies to any similar component having the same label irrespective of any other reference labels. A brief list of the Figures is below.

In the Figures, reference signs can be omitted as is consistent with accepted engineering practice; however, a skilled person will understand that the illustrated components are understood in the context of the Figures as a whole, of the accompanying writings about such Figures, and of the embodiments of the claimed inventions.

### DETAILED DESCRIPTION

The Figures and Detailed Description, only to provide knowledge and understanding, signify at least one ECIN. To minimize the length of the Detailed Description, while various features, structures or characteristics can be described together in a single embodiment, they also can be used in other embodiments without being written about. Variations of any of these elements, and modules, processes, machines, systems, manufactures or compositions disclosed by such embodiments and/or examples are easily used in commerce. The Figures and Detailed Description signify, implicitly or explicitly, advantages and improvements of at least one ECIN for use in commerce.

In the Figures and Detailed Description, numerous specific details can be described to enable at least one ECIN. Any embodiment disclosed herein signifies a tangible form of a claimed invention. To not diminish the significance of the embodiments and/or examples in this Detailed Description, some elements that are known to a skilled person can be combined together for presentation and for illustration purposes and not be specified in detail. To not diminish the significance of these embodiments and/or examples, some well-known processes, machines, systems, manufactures or compositions are not written about in detail. However, a skilled person can use these embodiments and/or examples in commerce without these specific details or their equivalents. Thus, the Detailed Description focuses on enabling the inventive elements of any ECIN. Where this Detailed Description refers to some elements in the singular tense, more than one element can be depicted in the Figures and like elements are labeled with like numerals.

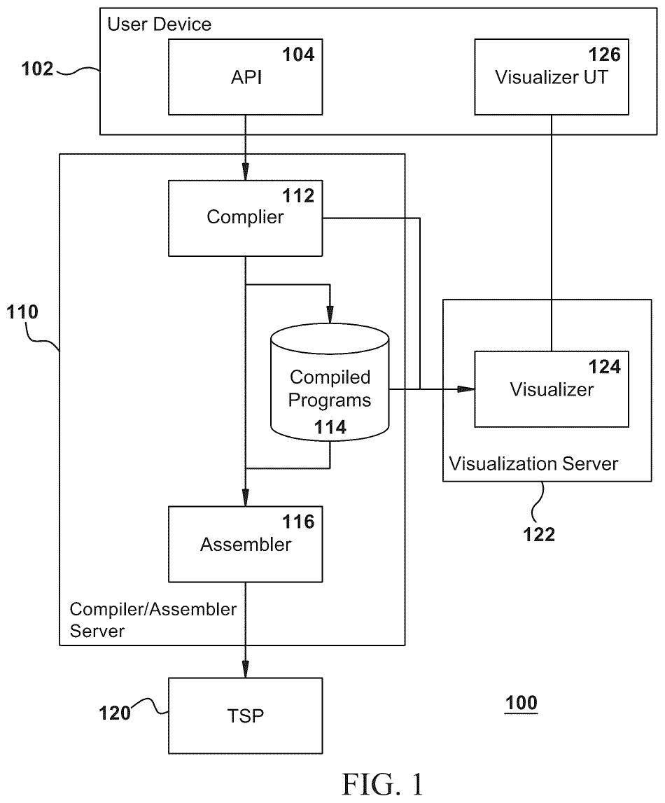

FIG. 1 illustrates a system 100 for compiling programs to be executed on a tensor processor, and for generating power usage information for the compiled programs, according to an embodiment. The system 100 includes a user device 102, a server 110, and a processor 120. Each of these components, and their sub-components (if any) are described in greater detail below. Although a particular configuration of components is described herein, in other embodiments the system 100 has different components and these components perform the functions of the system 100 in a different order or using a different mechanism. For example, while FIG. 1 illustrates a single server 110, in other embodiments, compilation, assembly, and power usage functions are performed on different devices. For example, in some embodiments, at least a portion of the functions performed by the server 110 are performed by the user device 102.

The user device 102 comprises any electronic computing device, such as a personal computer, laptop, or workstation, which uses an Application Program Interface (API) 104 to construct programs to be run on the processor 120. The server 110 receives a program specified by the user at the user device 102 and compiles the program to generate a compiled program 114. In some embodiments, a compiled program 114 enables a data model for predictions that processes input data and makes a prediction from the input data. Examples of predictions are category classifications made with a classifier, predictions of time series values, and so on. In some embodiments, the prediction model describes a machine learning model that includes nodes, tensors, and weights. In one embodiment, the prediction model is specified as a TensorFlow model, the compiler 112 is a TensorFlow compiler and the processor 120 is a tensor processor. In another embodiment, the prediction model is specified as a PyTorch model, the compiler is a PyTorch compiler. In other embodiments, other machine learning specification languages and compilers are used. For example, in some embodiments, the prediction model defines nodes representing operators (e.g., arithmetic operators, matrix transformation operators, Boolean operators, etc.), tensors representing operands (e.g., values that the operators modify, such as scalar values, vector values, and matrix values, which may be represented in integer or floating-point format), and weight values that are generated and stored in the model after training. In some embodiments, where the processor 120 is a tensor processor having a functional slice architecture, the compiler 112 generates an explicit plan for how the processor will execute the program, by translating the program into a set of operations that are executed by the processor 120, specifying when each instruction will be executed, which functional slices will perform the work, and which stream registers will hold the operands. This type of scheduling is known as “deterministic scheduling”. This explicit plan for execution includes information for explicit prediction of excessive power usage by the processor when executing the program.

The assembler 116 receives compiled programs 114, generated by the compiler 112, and performs final compilation and linking of the scheduled instructions to generate a compiled binary. In some embodiments, the assembler 116 maps the scheduled instructions indicated in the compiled program 114 to the hardware of the server 110, and then determines the exact component queue in which to place each instruction.

The processor 120, for example, is a hardware device with a massive number (or a large number) of matrix multiplier units that accepts a compiled binary assembled by the assembler 116, and executes the instructions included in the compiled binary. The processor 120 can include one or more blocks of circuitry for matrix arithmetic, numerical conversion, vector computation, short-term memory, and data permutation/switching. Once such processor 120 is a tensor processor having a functional slice architecture. In some embodiments, the processor 120 comprises multiple tensor processors connected together.

### Example Processor

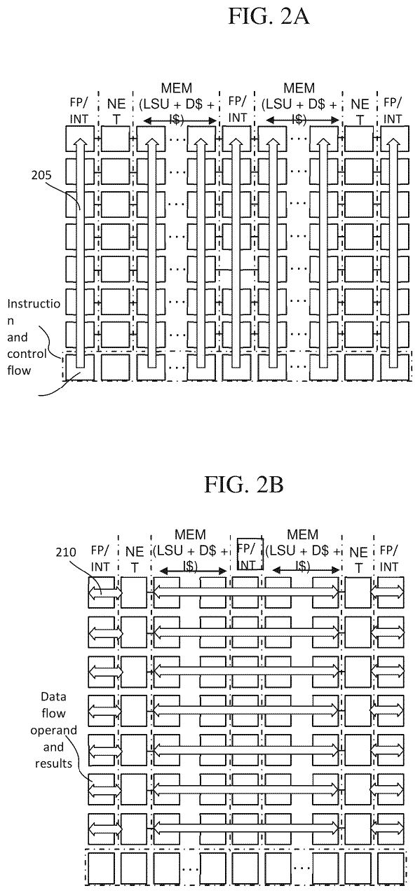

FIGS. 2A and 2B illustrate instruction and data flow in a processor having a functional slice architecture, in accordance with some embodiments. One enablement of processor 200 is as an application specific integrated circuit (ASIC) and corresponds to processor 120 illustrated in FIG. 1.

The functional units of processor 200 (also referred to as “functional tiles”) are aggregated into a plurality of functional process units (hereafter referred to as “slices”) 205, each corresponding to a particular function type in some embodiments. For example, different functional slices of the processor correspond to processing units for MEM (memory), VXM (vector execution module), MXM (matrix execution module), NIM (numerical interpretation module), and SXM (switching and permutation module). In other embodiments, each tile may include an aggregation of functional units such as a tile having both MEM and execution units by way of example. As illustrated in FIGS. 2A and 2B, each slice corresponds to a column of N functional units extending in a direction different (e.g., orthogonal) to the direction of the flow of data. The functional units of each slice can share an instruction queue (not shown) that stores instructions, and an instruction control unit (ICU) 210 that controls execution flow of the instructions. The instructions in a given instruction queue are executed only by functional units in the queue's associated slice and are not executed by another slice of the processor. In other embodiments, each functional unit has an associated ICU that controls the execution flow of the instructions.

Processor 200 also includes communication lanes to carry data between the functional units of different slices. Each communication lane connects to each of the slices 205 of processor 200. In some embodiments, a communication lane 220 that connects a row of functional units of adjacent slices is referred to as a “super-lane”, and comprises multiple data lanes, or “streams”, each configured to transport data values along a particular direction. For example, in some embodiments, each functional unit of processor 200 is connected to corresponding functional units on adjacent slices by a super-lane made up of multiple lanes. In other embodiments, processor 200 includes communication devices, such as a router, to carry data between adjacent functional units.

By arranging the functional units of processor 200 into different functional slices 205, the on-chip instruction and control flow of processor 200 is decoupled from the data flow. Since many types of data are acted upon by the same set of instructions, what is important for visualization is visualizing the flow of instructions, not the flow of data. For some embodiments, FIG. 2A illustrates the flow of instructions within the processor architecture, while FIG. 2B illustrates the flow of data within the processor architecture. As illustrated in FIGS. 2A and 2B, the instructions and control signals flow in a first direction across the functional units of processor 200 (e.g., along the length of the functional slices 205), while the data flows 220 flow in a second direction across the functional units of processor 200 (e.g., across the functional slices) that is non-parallel to the first direction, via the communication lanes (e.g., super-lanes) connecting the slices.

In some embodiments, the functional units in the same slice execute instructions in a ‘staggered’ fashion where instructions are issued tile-by-tile within the slice over a period of N cycles. For example, the ICU for a given slice may, during a first clock cycle, issues an instruction to a first tile of the slice (e.g., the bottom tile of the slice as illustrated in FIG. 1B, closest to the ICU of the slice), which is passed to subsequent functional units of the slice over subsequent cycles. That is, each row of functional units (corresponding to functional units along a particular super-lane) of processor 200 executes the same set of instructions, albeit offset in time, relative to the functional units of an adjacent row.

The functional slices of the processor are arranged such that operand data read from a memory slice is intercepted by different functional slices as the data moves across the chip, and results flow in the opposite direction where they are then written back to memory. For example, a first data flow from a first memory slice flows in a first direction (e.g., towards the right), where it is intercepted by a V×M slice that performs a vector operation on the received data. The data flow then continues to an M×M slice which performs a matrix operation on the received data. The processed data then flows in a second direction opposite from the first direction (e.g., towards the left), where it is again intercepted by V×M slice to perform an accumulate operation, and then written back to the memory slice.

In some embodiments, the functional slices of the processor are arranged such that data flow between memory and functional slices occur in both the first and second directions. For example, a second data flow originating from a second memory slice that travels in the second direction towards a second slice, where the data is intercepted and processed by V×M slice before traveling to the second M×M slice. The results of the matrix operation performed by the second M×M slice then flow in the first direction back towards the second memory slice.

In some embodiments, stream registers are located along a super-lane of the processor, in accordance with some embodiments. The stream registers are located between functional slices of the processor to facilitate the transport of data (e.g., operands and results) along each super-lane. For example, within the memory region of the processor, stream registers are located between sets of four MEM units. The stream registers are architecturally visible to the compiler and serve as the primary hardware structure through which the compiler has visibility into the program's execution. Each functional unit of the set contains stream circuitry configured to allow the functional unit to read or write to the stream registers in either direction of the super-lane. In some embodiments, each stream register is implemented as a collection of registers, corresponding to each stream of the super-lane, and sized based upon the basic data type used by the processor (e.g., if the TSP's basic data type is an INT8, each register may be 8-bits wide). In some embodiments, in order to support larger operands (e.g., FP16 or INT32), multiple registers are collectively treated as one operand, where the operand is transmitted over multiple streams of the super-lane.

All of these functional features-superlanes of functional units, slices of instruction flow, handling of different types of integers and floating-point numbers, occurring trillions of times a second, create complicated power flows and possible disruptive power fluctuations that could negatively impact the performance of the processor. However, given the deterministic nature of executions by the processor, any disruptive power fluctuations (such as voltage droop) can be determined before execution of the program, with information (such as processor instructions, and timing for such instructions) about such fluctuations being supplied by the compiler to the processor, for the processor to use during program execution to mitigate the fluctuations.

### Proactive Thermal Management

The operation temperature of processors is constrained by the underlying reliability of the transistors and interconnects of the utilized technology node. In order to ensure adequate lifetime and reliable operation of the processor at full performance, adequate margins are added during the processor design phase, along with the assumption that the processor temperature is not allowed to exceed a certain critical temperature (T_{crit}).

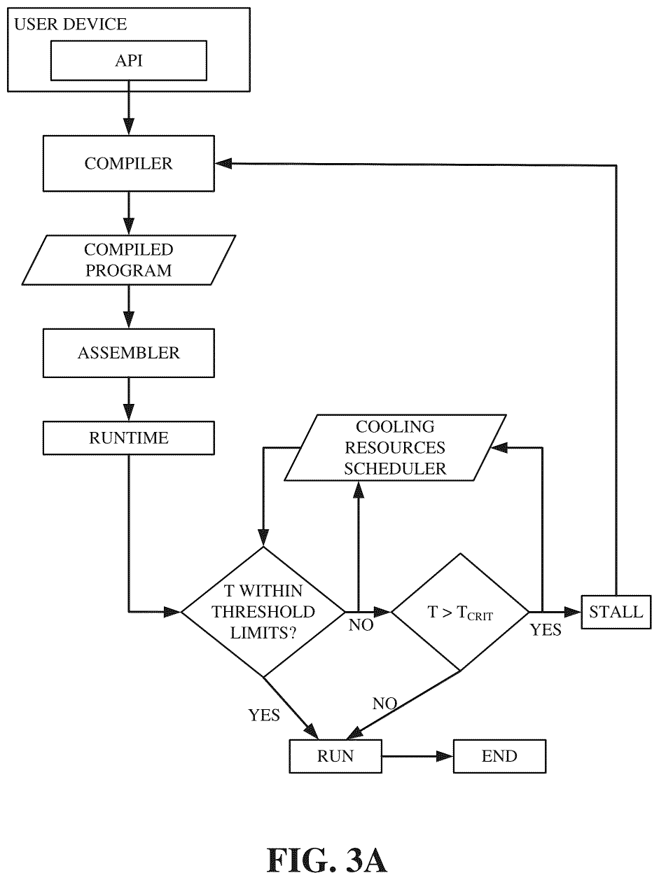

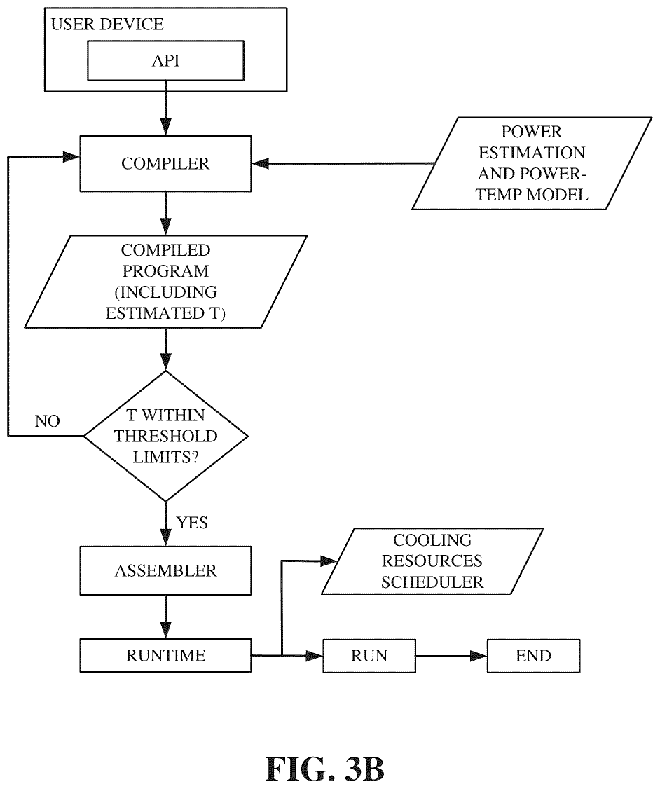

FIG. 3A illustrates the traditional reactive thermal management procedure wherein compiled programs are run on the processor, while the runtime software periodically monitors the on-processor temperature sensors to detect temperature excursions that exceed T_{crit}. Since temperature excursions beyond T_{crit} are physically damaging to the processor, workload execution is interrupted when temperature approaches T_{crit}. Such interruptions in the execution of the workload cannot be predicted in advance and is extremely expensive in terms of latency and throughput.

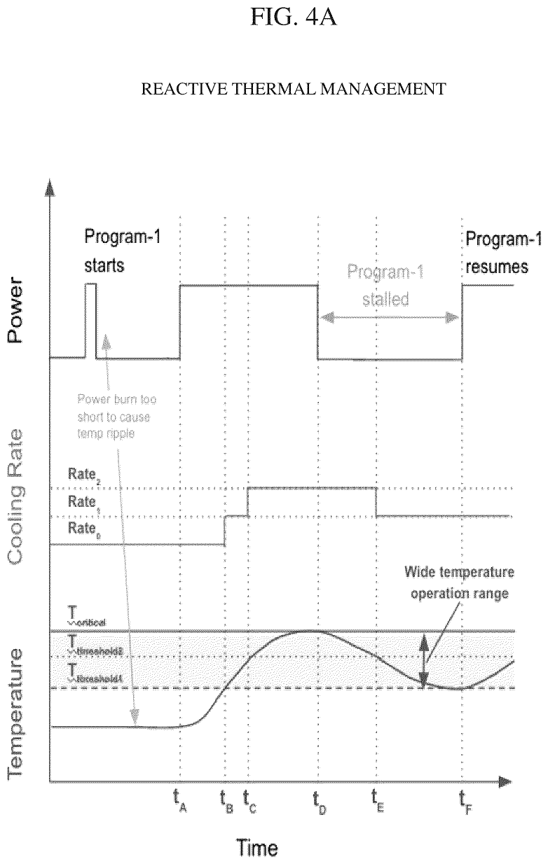

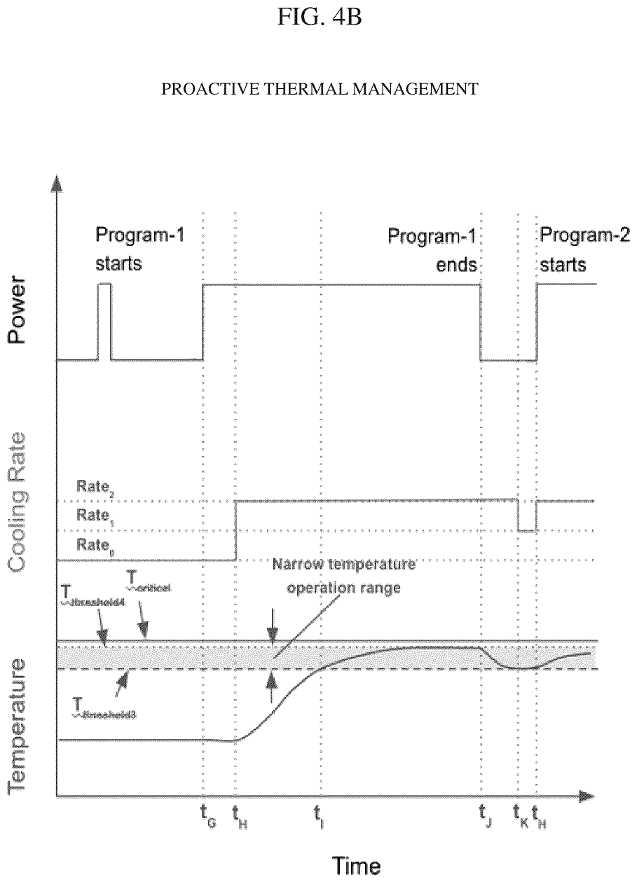

FIG. 4A illustrates the processor power consumption, cooling rate, and processor temperature profile of a system that uses the reactive method to run a nominal workload. The rise in processor temperature occurs only if sufficient power is being consumed for a long enough time such that it exceeds the thermal time constant of the system. In other words, high power consumption for short intervals below the thermal time constant does not affect processor temperature. The reactive cooling technique involves implementing multiple temperature threshold limits (T_{threshold1,} T_{threshold2}) across a wide range (shown as the yellow shaded region) to first detect, and then schedule adequate cooling resources (by raising cooling rates from rate₀ to rate₁, rate₂ at times t_{B}, t_{C} respectively) to prevent processor temperature from exceeding T_{crit}. Nevertheless, the lack of information about the future processor temperature profile during a workload execution has prevented the implementation of a foolproof mechanism to always avoid interrupts such as the one shown at time t_{d}. Interruptions in program execution results in unexpected and (usually) long downtimes of the system until the processor has cooled to a sufficiently low temperature threshold (T_{threshold1}) such that program execution can restart (at time t_{F}).

In one ECIN, a proactive thermal management procedure shown in FIG. 3-B is used to avoid the problems mentioned previously. The compiler is programmed to extract the power consumption profile and the resulting temperature profile of a given scheduled workload, which is used to identify and implement appropriate methods (detailed in subsequent embodiments) to always maintain the processor temperature within acceptable limits, without any uncertainty.

FIG. 4B illustrates the processor power consumption, cooling rate, and processor temperature profile of a proactively managed thermal system while running a nominal workload.

A significant benefit of the a priori knowledge of power (and its resulting temperature) profile is the ability to actively maintain the processor temperature within a much narrower range (between T_{threshold3} and T_{threshold4}), while remaining below T_{crit} (as shown in the green shaded region) and allowing to utilize the maximum performance of the processor for a maximum amount of time. The compiler schedules the execution of workload such that cooling rate is increased (from rate₀ to rate₂ at time t_{H}) prior to the processor temperature reaching any predetermined threshold temperature (such as at time t_{I}), which is the case with the currently used reactive approach. Identifying potential unsafe temperature excursions and/or thermal runaway during compile time and appropriately pre-scheduling resources to avoid unwanted thermal issues prior to any workload execution on the processor allows for maximizing performance and prevents the pitfalls of the unexpected and prohibitively expensive downtimes of the reactive approach. Another benefit of the proactive approach is to provide additional optionality for different applications to balance energy consumption and system performance. For example, for energy resource limited applications, proactive management can save significantly on the cooling power and associated costs by avoiding unnecessary usage of cooling resources when the processor temperature is below the specified temperature range.

During the execution of a workload, there will be circumstances when the power consumed by the processor exceeds the thermal design power (TDP) of the system. A proactive thermal management approach allows the compiler to reallocate and reschedule resource use within the processor, in order to maintain the temperature within the narrow operation range. Such reallocation can be achieved by reordering the operations, and/or splitting the workload into smaller chunks, and/or selectively inserting low and/or almost-zero power operations (like No-Ops), and/or any other available methods.

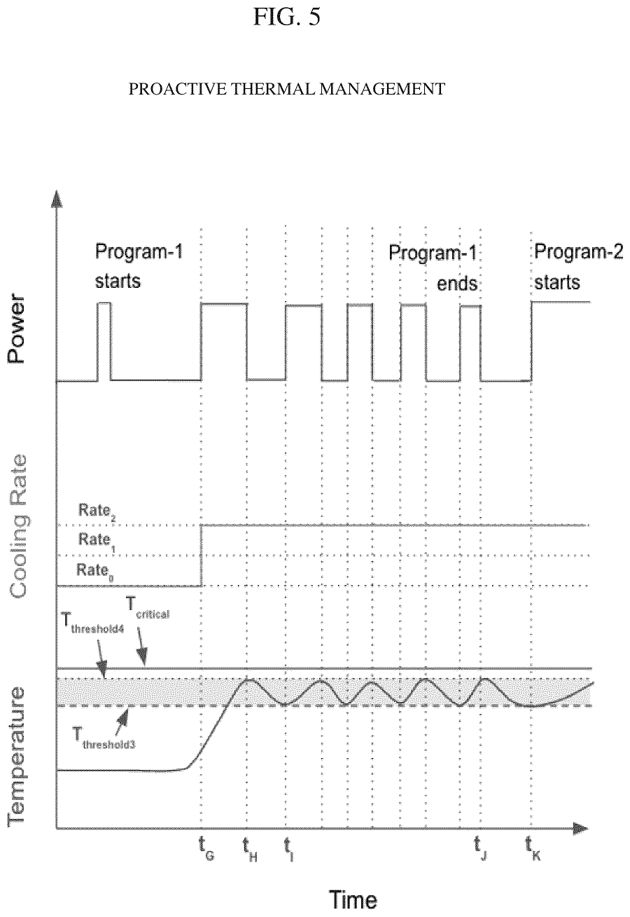

FIG. 5 showcases the processor power consumption, cooling rate, and processor temperature profile of such a power-heavy workload on the proactively managed system, where the processor temperature oscillates and stays within the desired narrow safe operation range throughout the execution.

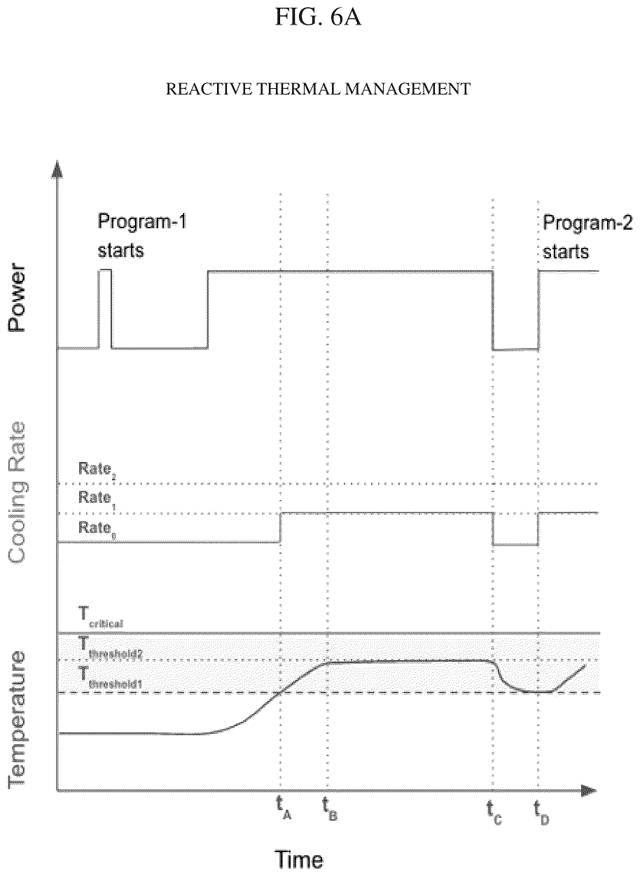

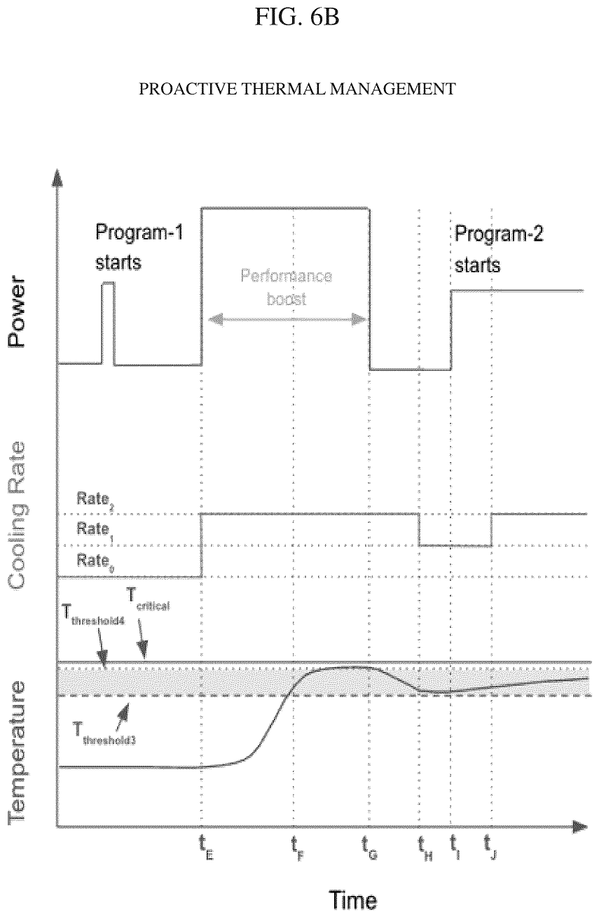

In another ECIN, the power and thermal aware compiler maximizes the use of available compute resources while minimizing latency and increasing throughput. This is beneficial especially during execution of low power intensity workloads. FIGS. 6-A and 6-B illustrate the processor power consumption, cooling rate, and processor temperature profiles during execution of a low power intensity workload on reactively and proactively managed systems respectively. The lack of information about the exact temperature profile during a workload leads to worst-case assumptions of temperature and underutilized chip/system capacity leading to a longer workload execution times. The compiler in a proactively thermal aware system can alter resource allocation to maximize the utilization of the processor compute resources while minimizing the total latency and increasing the overall throughput. Such resource allocation can be in the form of (but not limited to) increasing processor frequency using dynamic voltage-frequency scaling, and/or increasing on-chip compute resource utilization by parallel execution, and/or other available methods.

Compute systems usually consist of multiple processors on a single blade/rack/node. In a proactive thermal management approach, the a priori knowledge of the physical location of processors vis-a-vis the cooling resources can be used to further optimize the efficiency of the entire system.

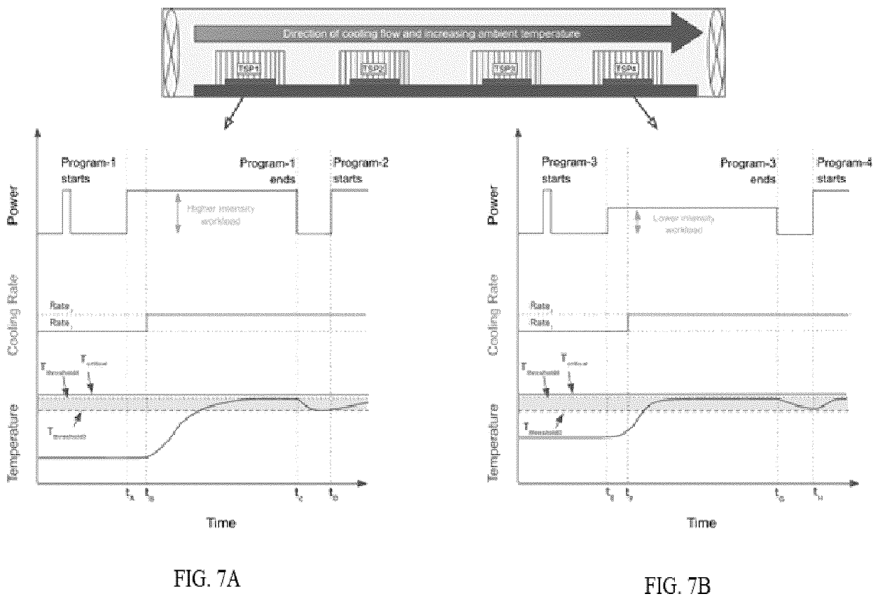

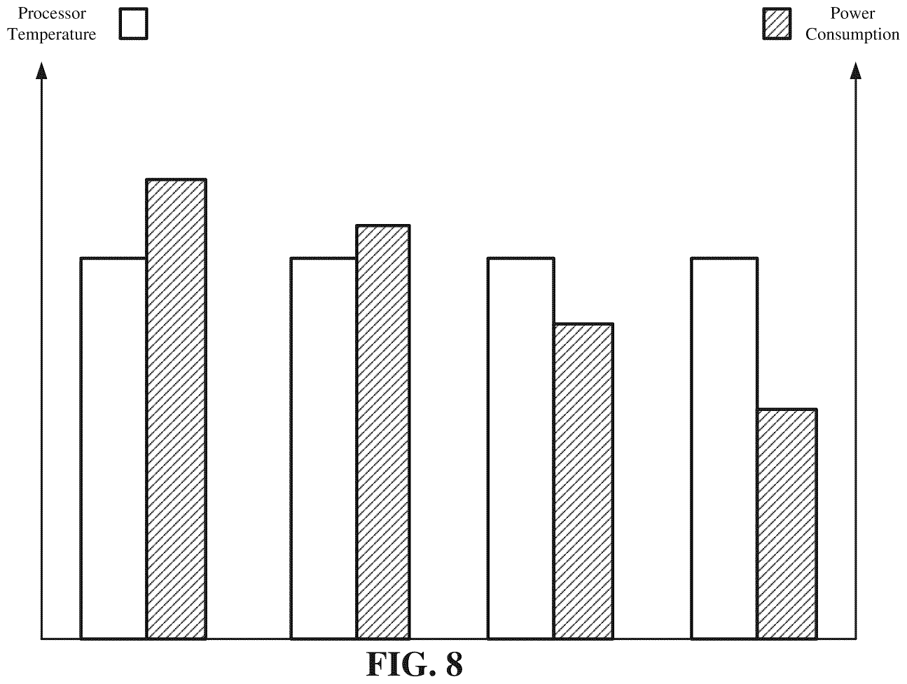

In another ECIN, FIG. 7A and FIG. 7B illustrate the difference in ambient temperature of the cooling solution based on the direction of cooling flow and increasing ambient temperature within a system comprising multiple processors. FIGS. 7A and 7B illustrate using proactive management for a system comprising four processors in a row in a single rack. A low temperature cooling medium enters the rack from the left, extracting heat from the processors, and exits the rack from the right at higher temperatures. The left-most processor (TSP1) interacts with the cooling medium at a lower temperature (for example ambient room temperature) than that of the right-most processor (TSP4). The difference in the cooling medium temperatures between the processors is used to adjust an individual workload and/or allocate multiple workloads of varying power intensities to different processors while being cognizant of their location specific thermal environment. The compiler is provided with information about the thermal environments of each processor in the form of a log file that can contain (but not limited to) the physical location, ambient temperature, etc.). In order to achieve maximum utilization efficiency of the system, it is desirable to allocate higher power intensity workloads to processors with lowest ambient temperature (TSP1) and vice-versa (lowest power intensity workload allocated to TSP4 which experiences highest ambient temperature). Such an allocation facilitates the maintenance of the processor temperatures within the narrow safe-range of operation, even as the ambient temperature changes across the rack, as highlighted in FIG. 8.

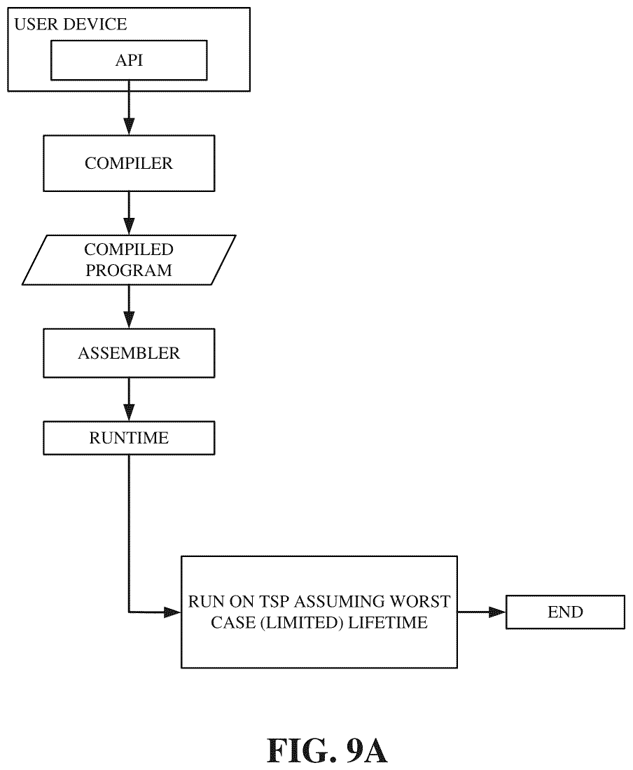

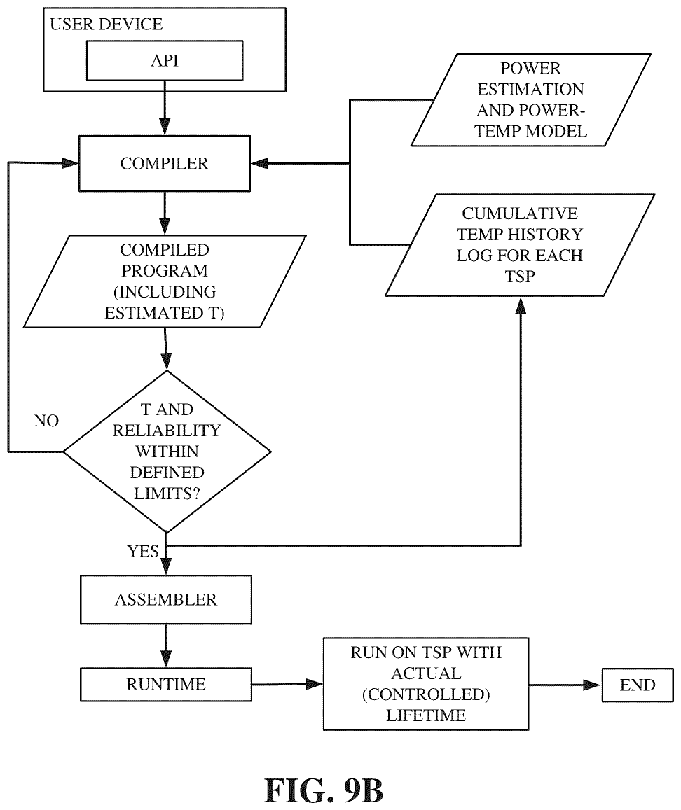

A proactive approach to thermal management also allows multiple design choices between processor performance and lifecycle management. The reliability and lifetime of a processor is inverse-exponentially dependent on the temperatures it is subjected to. A proactive thermal aware compiler can make the necessary trade offs during compilation and maintain the long-term rolling average temperature of the processor at a lower temperature to extend the processor lifetime, at the expense of workload latency. In order for the compiler to make accurate lifespan estimates, the cumulative thermal profile history of each processor can be stored and made available during the compilation. Such a luxury of extending reliability and lifetime is not available to current reactive thermal management approaches. The necessary differences in the procedures are delineated in FIGS. 9-A and 9-B for the reactive and proactive methods respectively.

An embodiment relates to a method that includes determining, by a compiler of a deterministic processor, an estimated power consumption and a resulting temperature profile of a scheduled workload over time. The method also includes facilitating, by the compiler, mitigation of a temperature excursion that exceeds a defined temperature threshold, wherein the determining and the facilitating are performed before an execution of the scheduled workload on the deterministic processor.

The determining can include extracting a power consumption profile and an associated temperature profile of the scheduled workload from a profile database.

In some embodiments, the facilitating can include scheduling the execution of the scheduled workload such that a cooling rate is increased from a first cooling rate to a second cooling rate at a defined time. Further to these embodiments, the defined time is a time prior to a temperature of the deterministic processor reaching the defined temperature threshold.

According to some embodiments, the facilitating comprises balancing energy consumption and performance of the deterministic processor.

In some embodiments, the method can include determining, by the compiler and during the execution of the scheduled workload, that a power consumed by the deterministic processor satisfies a thermal design power threshold. Further, the method can include reallocating, by the compiler, resource use within the deterministic processor, wherein the reallocating facilitates maintaining a temperature of the deterministic processor within a defined narrow operating range. In some embodiments, the reallocating can include reordering execution of a plurality of operations within the deterministic processor. According to some embodiments, the reallocating can include dividing the scheduled workload into smaller chunks (e.g., smaller workloads). In some embodiments, the reallocating can include selectively inserting lower power operations of the scheduled workload between higher power operations of the scheduled workload during the execution.

Another embodiment relates to a method to improve operation of a compiler of a deterministic processor to calculate an estimated power consumption and a resulting temperature profile of a program or workload over time, which is calculated before the execution of the program on the deterministic processor using information about the workload to proactively manage a system temperature, before the program has begun execution, to minimize temperature excursions outside a specific safe range.

Detailed Description—Technology Support from Data/Instructions to Processors/Programs

Data and Information. While ‘data’ and ‘information’ often are used interchangeably (e.g., ‘data processing’ and ‘information processing’), the term ‘datum’ (plural ‘data’) typically signifies a representation of the value of a fact (e.g., the measurement of a physical quantity such as the current in a wire, or the price of gold), or the answer to a question (e.g., “yes” or “no”), while the term ‘information’ typically signifies a set of data with structure (often signified by ‘data structure’). A data structure is used in commerce to transform an electronic device for use as a specific machine as an article of manufacture (see In re Lowry, 32 F.3d 1579 [CAFC, 1994]). Data and information are physical objects, for example binary data (a ‘bit’, usually signified with ‘0’ and ‘1’) enabled with two levels of voltage in a digital circuit or electronic component. For example, data can be enabled as an electrical, magnetic, optical or acoustical signal or state; a quantum state such as a particle spin that enables a ‘qubit’; or a physical state of an atom or molecule. All such data and information, when enabled, are stored, accessed, transferred, combined, compared, or otherwise acted upon, actions that require and dissipate energy.

As used herein, the term ‘process’ signifies an artificial finite ordered set of physical actions (‘action’ also signified by ‘operation’ or ‘step’) to produce at least one result Some types of actions include transformation and transportation. An action is a technical application of one or more natural laws of science or artificial laws of technology. An action often changes the physical state of a machine, of structures of data and information, or of a composition of matter. Two or more actions can occur at about the same time, or one action can occur before or after another action, if the process produces the same result. A description of the physical actions and/or transformations that comprise a process are often signified with a set of gerund phrases (or their semantic equivalents) that are typically preceded with the signifier ‘the steps of’ (e.g., “a process comprising the steps of measuring, transforming, partitioning and then distributing . . . ”). The signifiers ‘algorithm’, ‘method’, ‘procedure’, ‘(sub) routine’, ‘protocol’, ‘recipe’, and ‘technique’ often are used interchangeably with ‘process’, and 35 U.S.C. 100 defines a “method” as one type of process that is, by statutory law, always patentable under 35 U.S.C. 101. As used herein, the term ‘thread’ signifies a subset of an entire process. A process can be partitioned into multiple threads that can be used at or about at the same time.

As used herein, the term ‘rule’ signifies a process with at least one logical test (signified, e.g., by ‘IF test IS TRUE THEN DO process’). As used herein, a ‘grammar’ is a set of rules for determining the structure of information. Many forms of knowledge, learning, skills and styles are authored, structured, and enabled-objectively—as processes and/or rules—e.g., knowledge and learning as functions in knowledge programming languages.

As used herein, the term ‘component’ (also signified by ‘part’, and typically signified by ‘element’ when described in a patent text or diagram) signifies a physical object that is used to enable a process in combination with other components. For example, electronic components are used in processes that affect the physical state of one or more electromagnetic or quantum particles/waves (e.g., electrons, photons) or quasiparticles (e.g., electron holes, phonons, magnetic domains) and their associated fields or signals. Electronic components have at least two connection points which are attached to conductive components, typically a conductive wire or line, or an optical fiber, with one conductive component end attached to the component and the other end attached to another component, typically as part of a circuit with current or photon flows. There are at least three types of electrical components: passive, active and electromechanical. Passive electronic components typically do not introduce energy into a circuit-such components include resistors, memristors, capacitors, magnetic inductors, crystals, Josephson junctions, transducers, sensors, antennas, waveguides, etc. Active electronic components require a source of energy and can inject energy into a circuit-such components include semiconductors (e.g., diodes, transistors, optoelectronic devices), vacuum tubes, batteries, power supplies, displays (e.g., LEDs, LCDs, lamps, CRTs, plasma displays). Electromechanical components affect current flow using mechanical forces and structures-such components include switches, relays, protection devices (e.g., fuses, circuit breakers), heat sinks, fans, cables, wires, terminals, connectors and printed circuit boards.

As used herein, the term ‘netlist’ is a specification of components comprising an electric circuit, and electrical connections between the components. The programming language for the SPICE circuit simulation program is often used to specify a netlist. In the context of circuit design, the term ‘instance’ signifies each time a component is specified in a netlist.

One of the most important components as goods in commerce is the integrated circuit, and its res of abstractions. As used herein, the term ‘integrated circuit’ signifies a set of connected electronic components on a small substrate (thus the use of the signifier ‘chip’) of semiconductor material, such as silicon or gallium arsenide, with components fabricated on one or more layers. Other signifiers for ‘integrated circuit’ include ‘monolithic integrated circuit’, ‘IC’, ‘chip’, ‘microchip’ and ‘System on Chip’ (‘SoC’). Examples of types of integrated circuits include gate/logic arrays, processors, memories, interface chips, power controllers, and operational amplifiers. The term ‘cell’ as used in electronic circuit design signifies a specification of one or more components, for example, a set of transistors that are connected to function as a logic gate. Cells are usually stored in a database, to be accessed by circuit designers and design processes.

As used herein, the term ‘module’ signifies a tangible structure for acting on data and information. For example, the term ‘module’ can signify a process that transforms data and information, for example, a process comprising a computer program (defined below). The term ‘module’ also can signify one or more interconnected electronic components, such as digital logic devices. A process comprising a module, if specified in a programming language (defined below), such as System C or Verilog, also can be transformed into a specification for a structure of electronic components that transform data and information that produce the same result as the process. This last sentence follows from a modified Church-Turing thesis, which is simply expressed as “Whatever can be transformed by a (patentable) process and a processor, can be transformed by a (patentable) equivalent set of modules.”, as opposed to the doublethink of deleting only one of the “(patentable)”.

A module is permanently structured (e.g., circuits with unalterable connections), temporarily structured (e.g., circuits or processes that are alterable with sets of data), or a combination of the two forms of structuring. Permanently structured modules can be manufactured, for example, using Application Specific Integrated Circuits (‘ASICs’) such as Arithmetic Logic Units (‘ALUs’), Programmable Logic Arrays (‘PLAs’), or Read Only Memories (‘ROMs’), all of which are typically structured during manufacturing. For example, a permanently structured module can comprise an integrated circuit. Temporarily structured modules can be manufactured, for example, using Field Programmable Gate Arrays (FPGAs—for example, sold by Xilink or Intel's Altera), Random Access Memories (RAMs) or microprocessors. For example, data and information is transformed using data as an address in RAM or ROM memory that stores output data and information. One can embed temporarily structured modules in permanently structured modules (for example, a FPGA embedded into an ASIC).

Modules that are temporarily structured can be structured during multiple time periods. For example, a processor comprising one or more modules has its modules first structured by a manufacturer at a factory and then further structured by a user when used in commerce. The processor can comprise a set of one or more modules during a first time period, and then be restructured to comprise a different set of one or modules during a second time period. The decision to manufacture or implement a module in a permanently structured form, in a temporarily structured form, or in a combination of the two forms, depends on issues of commerce such as cost, time considerations, resource constraints, tariffs, maintenance needs, national intellectual property laws, and/or specific design goals [FACT]. How a module is used, its function, is mostly independent of the physical form in which it is manufactured or enabled. This last sentence also follows from the modified Church-Turing thesis.

As used herein, the term ‘processor’ signifies a tangible data and information processing machine for use in commerce that physically transforms, transfers, and/or transmits data and information, using at least one process. A processor consists of one or more modules, e.g., a central processing unit (‘CPU’) module; an input/output (′I/O′) module, a memory control module, a network control module, and/or other modules. The term ‘processor’ can also signify one or more processors, or one or more processors with multiple computational cores/CPUs, specialized processors (for example, graphics processors or signal processors), and their combinations. Where two or more processors interact, one or more of the processors can be remotely located relative to the position of the other processors. Where the term ‘processor’ is used in another context, such as a ‘chemical processor’, it will be signified and defined in that context.

The processor can comprise, for example, digital logic circuitry (for example, a binary logic gate), and/or analog circuitry (for example, an operational amplifier). The processor also can use optical signal processing, DNA transformations, quantum operations, microfluidic logic processing, or a combination of technologies, such as an optoelectronic processor. For data and information structured with binary data, any processor that can transform data and information using the AND, OR and NOT logical operations (and their derivatives, such as the NAND, NOR, and XOR operations) also can transform data and information using any function of Boolean logic. A processor such as an analog processor, such as an artificial neural network, also can transform data and information. No scientific evidence exists that any of these technological processors are processing, storing and retrieving data and information, using any process or structure equivalent to the bioelectric structures and processes of the human brain.

The one or more processors also can use a process in a ‘cloud computing’ or ‘timesharing’ environment, where time and resources of multiple remote computers are shared by multiple users or processors communicating with the computers. For example, a group of processors can use at least one process available at a distributed or remote system, these processors using a communications network (e.g., the Internet, or an Ethernet) and using one or more specified network interfaces (‘interface’ defined below) (e.g., an application program interface (‘API’) that signifies functions and data structures to communicate with the remote process).

As used herein, the term ‘computer’ and ‘computer system’ (further defined below) includes at least one processor that, for example, performs operations on data and information such as (but not limited to) the Boolean logical operations using electronic gates that can comprise transistors, with the addition of memory (for example, memory structured with flip-flops using the NOT-AND or NOT-OR operation). Any processor that can perform the logical AND, OR and NOT operations (or their equivalent) is Turing-complete and computationally universal [FACT]. A computer can comprise a simple structure, for example, comprising an I/O module, a CPU module, and a memory that performs, for example, the process of inputting a signal, transforming the signal, and outputting the signal with no human intervention.

As used herein, the term ‘programming language’ signifies a structured grammar for specifying sets of operations and data for use by modules, processors and computers. Programming languages include assembler instructions, instruction-set-architecture instructions, machine instructions, machine dependent instructions, microcode, firmware instructions, state-setting data, or either source code or object code written in any combination of one or more higher level languages, for example, the C programming language and similar general programming languages (such as Fortran, Basic, Javascript, PHP, Python, C++), knowledge programming languages (such as Lisp, Smalltalk, Prolog, or CycL), electronic structure programming languages (such as VHDL, Verilog, SPICE or SystemC), text programming languages (such as SGML, HTML, or XML), or audiovisual programming languages (such as SVG, MathML, X3D/VRML, or MIDI), and any future equivalent programming languages. As used herein, the term ‘source code’ signifies a set of instructions and data specified in text form using a programming language. A large amount of source code for use in enabling any of the claimed inventions is available on the Internet, such as from a source code library such as Github.

As used herein, the term ‘program’ (also referred to as an ‘application program’) signifies one or more processes and data structures that structure a module, processor or computer to be used as a “specific machine” (see In re Alappat, 33 F3d 1526 [CAFC, 1991]). One use of a program is to structure one or more computers, for example, standalone, client or server computers, or one or more modules, or systems of one or more such computers or modules. As used herein, the term ‘computer application’ signifies a program that enables a specific use, for example, to enable text processing operations, or to encrypt a set of data. As used herein, the term ‘firmware’ signifies a type of program that typically structures a processor or a computer, where the firmware is smaller in size than a typical application program, and is typically not very accessible to or modifiable by the user of a computer. Computer programs and firmware are often specified using source code written in a programming language, such as C. Modules, circuits, processors, programs and computers can be specified at multiple levels of abstraction, for example, using the SystemC programming language, and have value as products in commerce as taxable goods under the Uniform Commercial Code (see U.C.C. Article 2, Part 1).

A program is transferred into one or more memories of the computer or computer system from a data and information device or storage system. A computer system typically has a device for reading storage media that is used to transfer the program, and/or has an interface device that receives the program over a network. This transfer is discussed in the General Computer Explanation section.

### Detailed Description—Technology Support General Computer Explanation

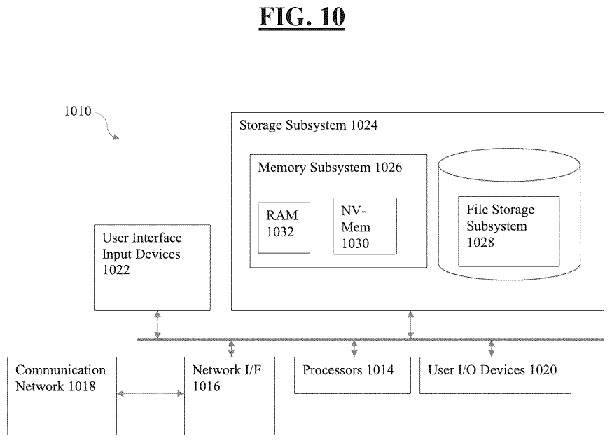

FIG. 10 depicts a computer system suitable for enabling embodiments of the claimed inventions.

In FIG. 10, the structure of computer system 1010 typically includes at least one computer 1014 which communicates with peripheral devices via bus subsystem 1012. Typically, the computer includes a processor (e.g., a microprocessor, graphics processing unit, or digital signal processor), or its electronic processing equivalents, such as an Application Specific Integrated Circuit (‘ASIC’) or Field Programmable Gate Array (‘FPGA’). Typically, peripheral devices include a storage subsystem 1024, comprising a memory subsystem 1026 and a file storage subsystem 1028, user interface input devices 1022, user interface output devices 1020, and/or a network interface subsystem 1016. The input and output devices enable direct and remote user interaction with computer system 1010. The computer system enables significant post-process activity using at least one output device and/or the network interface subsystem.

The computer system can be structured as a server, a client, a workstation, a mainframe, a personal computer (PC), a tablet PC, a set-top box (STB), a personal digital assistant (PDA), a cellular telephone, a smartphone, a web appliance, a rack-mounted ‘blade’, a kiosk, a television, a game station, a network router, switch or bridge, or any data processing machine with instructions that specify actions to be taken by that machine. The term ‘server’, as used herein, refers to a computer or processor that typically performs processes for, and sends data and information to, another computer or processor.

A computer system typically is structured, in part, with at least one operating system program, such as Microsoft's Windows, Sun Microsystems's Solaris, Apple Computer's MacOs and iOS, Google's Android, Linux and/or Unix. The computer system typically includes a Basic Input/Output System (BIOS) and processor firmware. The operating system, BIOS and firmware are used by the processor to structure and control any subsystems and interfaces connected to the processor. Typical processors that enable these operating systems include: the Pentium, Itanium and Xeon processors from Intel; the Opteron and Athlon processors from Advanced Micro Devices; the Graviton processor from Amazon; the POWER processor from IBM; the SPARC processor from Oracle; and the ARM processor from ARM Holdings.

Any ECIN is limited neither to an electronic digital logic computer structured with programs nor to an electronically programmable device. For example, the claimed inventions can use an optical computer, a quantum computer, an analog computer, or the like. Further, where only a single computer system or a single machine is signified, the use of a singular form of such terms also can signify any structure of computer systems or machines that individually or jointly use processes. Due to the ever-changing nature of computers and networks, the description of computer system 1010 depicted in FIG. 10 is intended only as an example. Many other structures of computer system 1010 have more or less components than the computer system depicted in FIG. 10.

Network interface subsystem 1016 provides an interface to outside networks, including an interface to communication network 1018, and is coupled via communication network 1018 to corresponding interface devices in other computer systems or machines. Communication network 1018 can comprise many interconnected computer systems, machines and physical communication connections (signified by ‘links’). These communication links can be wireline links, optical links, wireless links (e.g., using the WiFi or Bluetooth protocols), or any other physical devices for communication of information. Communication network 1018 can be any suitable computer network, for example a wide area network such as the Internet, and/or a local-to-wide area network such as Ethernet. The communication network is wired and/or wireless, and many communication networks use encryption and decryption processes, such as is available with a virtual private network. The communication network uses one or more communications interfaces, which receive data from, and transmit data to, other systems. Embodiments of communications interfaces typically include an Ethernet card, a modem (e.g., telephone, satellite, cable, or ISDN), (asynchronous) digital subscriber line (DSL) unit, Firewire interface, USB interface, and the like. Communication algorithms (‘protocols’) can be specified using one or communication languages, such as HTTP, TCP/IP, RTP/RTSP, IPX and/or UDP.

User interface input devices 1022 can include an alphanumeric keyboard, a keypad, pointing devices such as a mouse, trackball, toggle switch, touchpad, stylus, a graphics tablet, an optical scanner such as a bar code reader, touchscreen electronics for a display device, audio input devices such as voice recognition systems or microphones, eye-gaze recognition, brainwave pattern recognition, optical character recognition systems, and other types of input devices. Such devices are connected by wire or wirelessly to a computer system. Typically, the term ‘input device’ signifies all possible types of devices and processes to transfer data and information into computer system 1010 or onto communication network 1018. User interface input devices typically enable a user to select objects, icons, text and the like that appear on some types of user interface output devices, for example, a display subsystem.

User interface output devices 1020 can include a display subsystem, a printer, a fax machine, or a non-visual communication device such as audio and haptic devices. The display subsystem can include a cathode ray tube (CRT), a flat-panel device such as a liquid crystal display (LCD), an image projection device, or some other device for creating visible stimuli such as a virtual reality system. The display subsystem also can provide non-visual stimuli such as via audio output, aroma generation, or tactile/haptic output (e.g., vibrations and forces) devices. Typically, the term ‘output device’ signifies all possible types of devices and processes to transfer data and information out of computer system 1010 to the user or to another machine or computer system. Such devices are connected by wire or wirelessly to a computer system. Note: some devices transfer data and information both into and out of the computer, for example, haptic devices that generate vibrations and forces on the hand of a user while also incorporating sensors to measure the location and movement of the hand. Technical applications of the sciences of ergonomics and semiotics are used to improve the efficiency of user interactions with any processes and computers disclosed herein, such as any interactions with regards to the design and manufacture of circuits that use any of the above input or output devices.

Memory subsystem 1026 typically includes a number of memories including a main random-access memory (‘RAM’) 1030 (or other volatile storage device) for storage of instructions and data during program execution and a read only memory (‘ROM’) 1032 in which fixed instructions are stored. File storage subsystem 1028 provides persistent storage for program and data files, and can include a hard disk drive, a floppy disk drive along with associated removable media, a CD-ROM drive, an optical drive, a flash memory such as a USB drive, or removable media cartridges. If computer system 1010 includes an input device that performs optical character recognition, then text and symbols printed on paper can be used as a device for storage of program and data files. The databases and modules used by some embodiments can be stored by file storage subsystem 1028.

Bus subsystem 1012 provides a device for transmitting data and information between the various components and subsystems of computer system 1010. Although bus subsystem 1012 is depicted as a single bus, alternative embodiments of the bus subsystem can use multiple busses. For example, a main memory using RAM can communicate directly with file storage systems using Direct Memory Access (‘DMA’) systems.

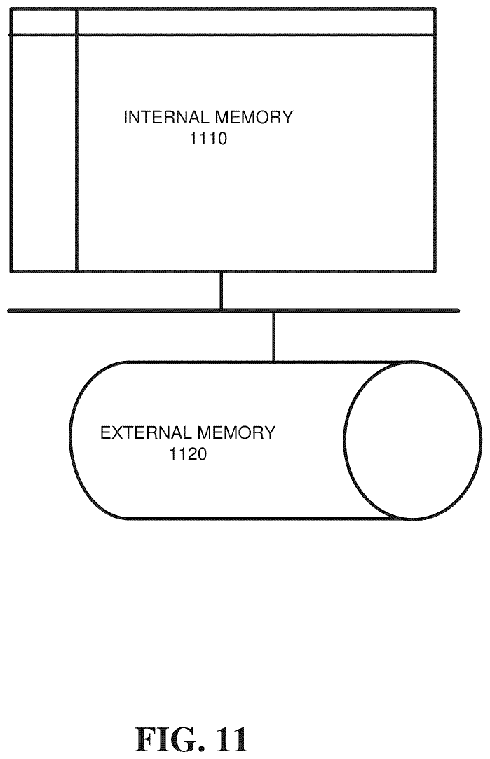

FIG. 11 depicts a memory 1110 such as a non-transitory, processor readable data and information storage medium associated with file storage subsystem 1028, and/or with network interface subsystem 1026, and can include a data structure specifying an AI model or workload. The memory 1120 can be a hard disk, a floppy disk, a CD-ROM, an optical medium, removable media cartridge, or any other medium that stores computer readable data in a volatile or non-volatile form, such as text and symbols on a physical object (such as paper) that can be processed by an optical character recognition system. A program transferred into and out of a processor from such a memory can be transformed into a physical signal that is propagated through a medium (such as a network, connector, wire, or circuit trace as an electrical pulse); or through a medium such as space or an atmosphere as an acoustic signal, or as electromagnetic radiation with wavelengths in the electromagnetic spectrum longer than infrared light).

### Detailed Description—Semantic Support

The signifier ‘commercial solution’ signifies, solely for the following paragraph, a technology domain-specific (and thus non-preemptive-see Bilski): electronic structure, process for a specified machine, manufacturable circuit (and its Church-Turing equivalents), or composition of matter that applies science and/or technology for use in commerce to solve an unmet need of technology.

The signifier ‘abstract’ (when used in a patent claim for any enabled embodiments disclosed herein for a new commercial solution that is a scientific use of one or more laws of nature {see Benson}, and that solves a problem of technology {see Diehr} for use in commerce—or improves upon an existing solution used in commerce {see Diehr})—is precisely defined by the inventor(s) {see MPEP 2111.01 (9th edition, Rev. 08.2017)} as follows
a) a new commercial solution is ‘abstract’ if it is not novel (e.g., it is so well known in equal prior art {see Alice} and/or the use of equivalent prior art solutions is long prevalent {see Bilski} in science, engineering or commerce), and thus unpatentable under 35 U.S.C. 102, for example, because it is ‘difficult to understand’ {see Merriam-Webster definition for ‘abstract’} how the commercial solution differs from equivalent prior art solutions; or
b) a new commercial solution is ‘abstract’ if the existing prior art includes at least one analogous prior art solution {see KSR}, or the existing prior art includes at least two prior art publications that can be combined {see Alice} by a skilled person {often referred to as a ‘PHOSITA’, see MPEP 2141-2144 (9th edition, Rev. 08.2017)} to be equivalent to the new commercial solution, and is thus unpatentable under 35 U.S.C. 103, for example, because it is ‘difficult to understand’ how the new commercial solution differs from a PHOSITA-combination/-application of the existing prior art; or
c) a new commercial solution is ‘abstract’ if it is not disclosed with a description that enables its praxis, either because insufficient guidance exists in the description, or because only a generic implementation is described {see Mayo} with unspecified components, parameters or functionality, so that a PHOSITA is unable to instantiate an embodiment of the new solution for use in commerce, without, for example, requiring special programming {see Katz} (or, e.g., circuit design) to be performed by the PHOSITA, and is thus unpatentable under 35 U.S.C. 112, for example, because it is ‘difficult to understand’ how to use in commerce any embodiment of the new commercial solution.

### DETAILED DESCRIPTION—CONCLUSION

The Detailed Description signifies in isolation the individual features, structures, functions, or characteristics described herein and any combination of two or more such features, structures, functions or characteristics, to the extent that such features, structures, functions or characteristics or combinations thereof are enabled by the Detailed Description as a whole in light of the knowledge and understanding of a skilled person, irrespective of whether such features, structures, functions or characteristics, or combinations thereof, solve any problems disclosed herein, and without limitation to the scope of the Claims of the patent. When an ECIN comprises a particular feature, structure, function or characteristic, it is within the knowledge and understanding of a skilled person to use such feature, structure, function, or characteristic in connection with another ECIN whether or not explicitly described, for example, as a substitute for another feature, structure, function or characteristic.

In view of the Detailed Description, a skilled person will understand that many variations of any ECIN can be enabled, such as function and structure of elements, described herein while being as useful as the ECIN. One or more elements of an ECIN can be substituted for one or more elements in another ECIN, as will be understood by a skilled person. Writings about any ECIN signify its use in commerce, thereby enabling other skilled people to similarly use this ECIN in commerce.

This Detailed Description is fitly written to provide knowledge and understanding. It is neither exhaustive nor limiting of the precise structures described, but is to be accorded the widest scope consistent with the disclosed principles and features. Without limitation, any and all equivalents described, signified or Incorporated By Reference (or explicitly incorporated) in this patent application are specifically incorporated into the Detailed Description In addition, any and all variations described, signified or incorporated with respect to any one ECIN also can be included with any other ECIN. Any such variations include both currently known variations as well as future variations, for example any element used for enablement includes a future equivalent element that provides the same function, regardless of the structure of the future equivalent element.

What is claimed is:

1. A method to improve operation of a compiler of a deterministic processor to calculate an estimated power consumption and a resulting temperature profile of a program or workload over time, which is calculated before the execution of the program on the deterministic processor using information about the workload to proactively manage a system temperature, before the program has begun execution, to minimize temperature excursions outside a specific safe range.

2. A method comprising:
determining, by a compiler of a deterministic processor, an estimated power consumption and a resulting temperature profile of a scheduled workload over time;
facilitating, by the compiler, mitigation of a temperature excursion that exceeds a defined temperature threshold, wherein the determining and the facilitating are performed before an execution of the scheduled workload on the deterministic processor.

3. The method of claim 2, wherein the determining comprises:
extracting a power consumption profile and an associated temperature profile of the scheduled workload from a profile database.

4. The method of claim 2, wherein the facilitating comprises:
scheduling the execution of the scheduled workload such that a cooling rate is increased from a first cooling rate to a second cooling rate at a defined time.

5. The method of claim 4, wherein the defined time is a time prior to a temperature of the deterministic processor reaching the defined temperature threshold.

6. The method of claim 2, wherein the facilitating comprises:
balancing energy consumption and performance of the deterministic processor.

7. The method of claim 2, further comprising:
determining, by the compiler and during the execution of the scheduled workload, that a power consumed by the deterministic processor satisfies a thermal design power threshold; and
reallocating, by the compiler, resource use within the deterministic processor, wherein the reallocating facilitates maintaining a temperature of the deterministic processor within a defined narrow operating range.

8. The method of claim 7, wherein the reallocating comprises reordering execution of a plurality of operations within the deterministic processor.

9. The method of claim 7, wherein the reallocating comprises dividing the scheduled workload into smaller chunks.

10. The method of claim 7, wherein the reallocating comprises selectively inserting lower power operations of the scheduled workload between higher power operations of the scheduled workload during the execution.
